(19) United States
(12) Patent Application Publication
(10) Pub. No.: US 2006/0281063 A1
(43) Pub. Date: Dec. 14, 2006

(54) Interactive Radiological sciences clinical training system

(76) Inventor: Lolita A. McClain, Bowie, MD (US)

Correspondence Address: BIOTECHPATENT. NET LLC, No. 221 5284 Randolph Road, Rockville, MD, 20852-2116, US

(21) Appl. No.: 11/150,092

(22) Filed: Jun. 13, 2005

(51) Int. Cl. G09B 23/28

(52) U.S. Cl. 434/262

(57) ABSTRACT

An interactive medical training device comprising a computer system having a display, wherein the computer system is programmed to provide education and training in radiological sciences, more particularly in radiological procedures that promote the diagnoses of many ailments and the treatment of cancer and/or tumors. The computer system simulates radiological procedures for medical practitioners, students, and patients. This aspect is achieved by configuring the system to display, on a portion of the display, a video window. The video window displays an interactive video segment illustrating a portion of the radiologic/radiation therapy procedure. The system requests a user to input information relating to a next step in the radiologic/radiation therapy procedure, which advantageously keeps the user engaged in the training session. This “next step” information may include, for example, selecting an appropriate medical instrument or selecting a location on the body for radiation therapy/radiologic procedure. The user inputs the requested information through an input device, such as a mouse, a keyboard, a touch-sensitive screen, or other input device, such as a remote control-like device. The system then receives and interprets the user input and informs the user as to whether the input is correct. Preferable, if the input is correct the system will display a prerecorded interactive video segment illustrating the next step of the radiologic/radiation therapy procedure.

### BACKGROUND OF THE INVENTION

1. Field of the Invention

The present invention generally relates to radiological science medical training devices, and more particularly to a system that provides interactive medical training for diagnosing and treatment procedures.

2. Discussion of the Related Art

In recent years, there has been an ever-growing increase in the expense of proper medical education and training. This recent trend spans the entire spectrum of medical disciplines, from podiatry to neurology. The high cost of a qualified instructor or proctor is responsible for a significant component of these costs. Minimizing, or at least reducing this cost, will reduce the overall cost of medical education and training. Therefore, various devices have been employed to reduce this “live” instructional cost component. To better illustrate the problem and devices employed to alleviate the problem, more specific reference will be made to the medical field involving radiological science medical procedures.

As is known, radiological sciences procedure involves the use of a remote control-like device, assisting in the placement of radiation/x-ray beams through an instrument positioned in proximity to a body part.

Recent advances to the forefront of radiological science procedures, however, has not occurred without concern. Indeed, the debate over adequate training and appropriate credentialing of this approach to medical procedure has been well documented. Relatively little investment has gone into the training of practitioners for the proper and safe performance of these procedures, notwithstanding the progress in the development of technology and equipment for advanced radiological science procedures.

Certainly, one effective method for training advanced medical procedures are the traditional instructional/practicum method. While this method may provide a viable option for medical students, interns, or resident practitioners, it is generally not a feasible option for most licensed general surgeons, due to the time and expense involved. Alternatively, a one or two day short course comprising lecture, video, and/or observation does not provide adequate training for more advanced medical procedures. It has been found that the learning curve for some advanced laparoscopic procedures, such as the total therapy approach to radiological science, may range as high as 20 to 30 cases. While some radiological science practitioners, particularly in urban areas, may be fortunate enough to establish proctorships with a radiological science instructor at a training center, these proctorships are often time prohibitive and fail to reach enough practitioners.

Another method of training includes the extensive use of videotapes, which present both lecture and video recordings of actual medical procedures. While the use of videotapes effectively reduces the cost associated with a live instructor or proctor, the limitations of video include the lack of interaction. In this regard, the video may, for example, demonstrate procedures only from certain views, or otherwise may illustrate only certain portions of the procedures. Furthermore, videos often show a procedure in a step-by-step fashion, cleanly edited of many difficulties and problems that may be encountered in a particular procedure, and which are invaluable in the learning process. In short, training exclusive by way of video fails to permit the free exchange of question and answer, and avoids the “hands-on” training that is essential to any quality educational/training program.

In order to achieve this “hands-on” training, mannequins are often used to supplement an alternative training program, such as a video program. Although the use of mannequins provides an effective method of achieving the coordinative skills of some radiologic science procedures, the anatomical divergence between a live human and a mannequin generally dampens the learning curve. Moreover, the use of mannequins is often very expensive, since universities, colleges, and other training institutions may be able to afford the actual mannequin but, not the multi million dollar radiological science equipment to perform the procedures itself.

Practitioners are currently trained with traditional “hands on” methods of observation and apprenticeship. A student of a new medical procedures are generally dependent on experienced practitioners for an introduction to the basic principles of the new procedures, a demonstration in performing the procedure and supervision during the initial attempts at performing the procedure. These traditional methods of training require constant supervision by highly skilled and licensed technologist, thus, limiting the number of persons who may be competently trained to perform such new procedures in a specified amount of time.

Organizations which have sought to train medical personnel in developing countries have found these traditional methods of training especially frustrating because of the limited availability of skilled persons and necessary facilities to provide such training. The students of the new procedures must be trained in all possible variations and consequences relating to the procedures. The students must then be provided with an opportunity to observe sample procedures and to perform the procedure under the supervision of experienced personnel. The number of persons which the organization may train effectively using these training techniques is limited to a few select radiological science student. Consequently, the organization has not been able to adequately train a sufficient numbers of technologist to diagnose and treat such conditions as cancer, which currently affect an estimated thirty-five million people worldwide.

Therefore, methods of educating and training persons in radiological science medical procedures, that avoid the problems described above, are desired. Indeed, although the foregoing discussion has focused upon medical therapy training, it can be appreciated that improved methods of medical training, that provide a cost-effective yet qualitative educational/training regimen, are broadly desired. In this regard, a training regimen that minimizes the cost associated with live instructive/proctored training component is desired.

### SUMMARY OF THE INVENTION

Accordingly, a primary object of the present invention is to provide an improved device for educating and training personnel in radiological science medical procedures.

Another object of the present invention is to provide an improved educational/training device for radiation therapy procedures.

Still another object of the present invention is to provide an educational/training device that realizes lower cost in the educational and training of radiological science procedures.

Yet another object of the present invention is to provide a low-cost medical educational and training device providing an interactive user environment.

Still another object of the present invention is to an educational/training tool for radiological science procedures that reduces the time for direct, live instructional or proctored involvement.

Additional objects, advantages and other novel features of the invention will be set forth in part in the description that follows and in part will become apparent to those skilled in the art upon examination of the following or may be learned with the practice of the invention. The objects and advantages of the invention may be realized and obtained by means of the instrumentalities and combinations particularly pointed out in the appended claims.

To achieve the foregoing and other objects, the present invention is generally directed to an interactive radiological science medical training device. In accordance with one aspect of the present invention, the training device includes a computer system having a display, wherein the computer system is programmed to provide education and training in radiological science procedures. This aspect is achieved by configuring the system to display, on a portion of the display, a video window. The video window displays a prerecorded interactive video segment illustrating a radiological science procedure. Means are provided for requesting a user to input information relating to a next step in the radiological science procedure, which advantageously keeps the user engaged in the training session. Corresponding means are provided for receiving user input, and may be provided in the form of a keyboard, a mouse, a touch-sensitive screen, or any number of other input/output devices used in connection with a typical computer system. Responsive to the information input by the user, additional means are provided for interpreting the information and informing the user as to whether the input is correct.

In accordance with yet another aspect of the present invention, the system may display, in the video window, a portion of a radiological science procedure. At some point, the system may freeze the video and request the user to input information regarding the use of the next diagnostic and/or therapy instrument. In this regard, the system may provide the user with a list of potential medical instruments, wherein the user may highlight any one of the instruments provided in the list for selection. The system may provide digitized photographic images of each of the medical instruments provided in the list of instruments to assist the user's selection. The system may further be configured to sequentially display these digital images, coincident with a given procedure being highlighted in the list.

Once the user has input a selection, the system informs the user if that selection is incorrect. This may be achieved by, for example, instructing the user by way of a prerecorded speech segment. Consistent with the concepts of the present invention, the system may be configured to either instruct the user on the proper answer requested, or may alternatively request the information until the user enters the appropriate answer. A correct entry may be acknowledged by simply proceeding with the display of the next video segment of the radiological science procedure.

In yet another embodiment, the information requested from the training system may relate to the size and/or location, for example, placement of a probe relative to a particular body part for diagnosis and/or treatment. It will be appreciated, that a variety of instructive requests may be posited to a user to enhance and facilitate the educational and learning process.

In accordance with another aspect of the present invention, the educational/training system may be configured to allow a user to select from a wide variety of medical procedures in which he or she wishes to view. In this regard, the invention may provide education training on a variety of radiological science procedures. Moreover, within any given procedure, the system may be configured to provide interactive video instruction that covers the entire medical procedure or, alternatively, allow the user to select a particular portion of a procedure for which training is desired. It will be appreciated that certain users may require or desire additional training only on certain aspects of a particular radiological science procedure. The present invention recognizes and responds to this desire by providing the aforementioned feature.

In accordance with yet another embodiment of the present invention, multiple video windows may be provided showing differing, yet simultaneous, views of a radiological science procedure. In this regard, a video window may be provided showing the external view of a radiological science procedure, while a second video window may illustrate the procedure as viewed internally through an optical lens. Yet a third window may be provided to graphically illustrate a cross-sectional side view of the tissue in the area where the medical procedure is to be performed. It will be appreciated that other similar video or visual windows may be provided on the display to facilitate the education and training consistent with the concepts of the present invention.

In accordance with yet another aspect of the present invention, a method is provided for interactively training a user in radiological science procedures. In accordance with this method, a user is requested to input information relating to a next step in a medical procedure. As mentioned above, this information may relate to the selection of a diagnostic and/or treatment instrument, the size or location of the area in consideration for diagnosis and/or treatments, or a variety of other questions. The system includes the steps of receiving the requested input and interpreting the requested input to determine whether it is correct. Finally, the method includes the steps of displaying an interactive video segment illustrating the next step of the procedure, if the user input is correct, or otherwise informing the user that the input was incorrect. The computer system periodically generating a random error relating to information inputted by the end user relating to the medical procedure from a set of predetermined errors which may occur in said radiological science medical procedure and displaying said random error.

### DESCRIPTION OF THE DRAWINGS

The accompanying drawings incorporated in and forming a part of the specification, illustrate several aspects of the present invention, and together with the description serve to explain the principles of the invention. In the drawings:

FIG. 1A is a diagram illustrating a stand-alone computer system;

FIG. 1B is is a diagram illustrating a client/server, multiple user computer system;

FIG. 2 is a diagram of a computer storage area illustrating area partitions for storing prerecorded video segments, photographic images, and other storage;

FIG. 3 is a software flowchart illustrating the top-level software operation in accordance with the preferred embodiment.

### DETAILED DESCRIPTION OF A PREFERRED EMBODIMENT

By way of example, the present invention is illustrated in terms of a system for use in training medical personnel in radiological science procedures. The example application described herein is only one example application of the present invention and is provided for the purpose of better explaining the present invention. The present invention may be applied to any number of other radiological science procedures. Thus, the present invention should not be limited to the specific example of radiological science procedures described herein.

The Hardware

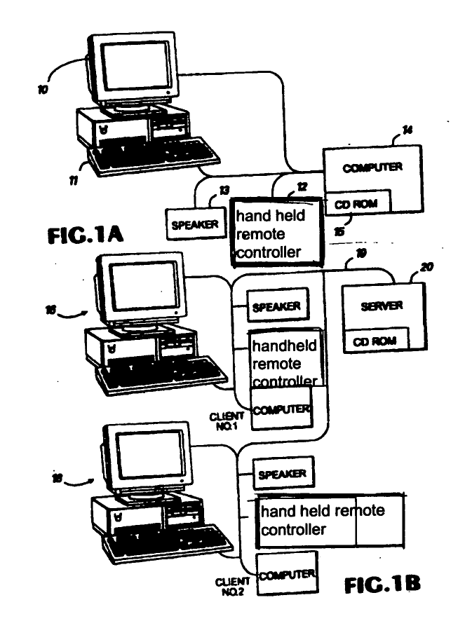

Shown in FIG. 1 is an example of a multimedia computer system 10 which could be employed to implement the present invention. In FIG. 1, a computer system 10 is shown having at least a 486 based 33 Mhz CPU based computer 1 with an internal hard drive, a disk drive 9 (which could also include a CD-ROM reader 8), a monitor 2, speakers 3 and a laser disk player 4 for playing a laser disk 5. The computer system 10 may also include a mouse 7 or a keyboard 6 which permits a user (not shown) to command and interface with the computer system 10. The monitor 2 may incorporate touch screen technology which would permit a user to select among various options by touching a specific area of the screen.

The computer system 10 could also incorporate other user interface devices such as a voice command recognition system, a pointer system or a dedicated command controller, either of which would permit a user to communicate commands and instructions to the computer system 10. The implementation of other user interface devices would be obvious to those skilled in the art and will not be discussed further herein.

In a preferred embodiment of the present invention, the laser disk player 4 is connected to the computer 1 through an internal board such as a Truevision Bravado 16 Bit Multimedia Engine available from the Truevision Corporation of Indianapolis, Ind.

The computer system 10 could also be provided with a separate recording mechanism 100 for recording all, or a selected portion of, the output and displays prescribed during the course of any training session. The recording mechanism 100 may be any standard VCR, or any other device which could record data in either analog or digital form and which could later be replayed and reviewed at the convenience of the user.

In a preferred embodiment, the computer system 10 includes a Truevision Bravado Encoder available from Truevision Corporation of Indianapolis, Ind. which Encoder delivers the video and audio display output of the system over a standard cable to a standard VCR recorder. The Encoder is preferably located within an expansion slot of the computer 1.

The various hardware components of the computer system 10 are coupled to the computer 1, via standard cable lines (not shown) in a manner well known to those skilled in the art. Alternatively, the components may be connected to the computer 1 via commercially available wireless communications networks.

Preferably, the computer system 10 should be portable, and simple to set up and use in remote areas. The computer system 10 should also be capable of receiving upgrades in hardware and software through existing expansion slots and connections. The computer system 10 should also be provided with a modem for receiving new and updated data at remote locations without the need for technical personnel.

The Interactive Programming

In a preferred embodiment of the present invention, the computer system 10 is programmed to provide an interactive diagnostic/treatment training system for the radiological science procedures.

The computer system 10 is programmed to provide an initial opening screen on the display monitor 2. The initial screen introduces the system to the user and provides the user with a menu from which he or she may select either a “help” program which provides a visual, audio and textual explanation of the various components of the system, or to begin the training exercise.

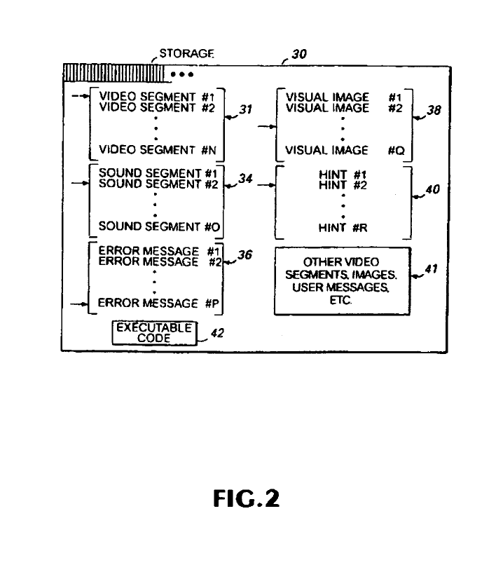

If the user elects to begin the exercise, a Main Menu screen is provided which permits the user to select between different radiological science procedures available on the system. Once the user makes a selection from the Main Menu Screen the user is provided another screen which lists various steps in the selected procedure to which the user may proceed for instruction. A flow chart of the Main Menu possibilities relating to radiological science procedures are shown in FIG. 2.

As shown in FIG. 2, once the user proceeds from the Main Menu screen to additional screens, the user may select either a help menu, which is preferably made available at every screen of the program wherein a user may select various commands, or one of several specific steps in the radiation therapy procedures for which detailed instruction is available. Once the user selects a specific step in the procedure, the system automatically updates the monitor to display the appropriate output.

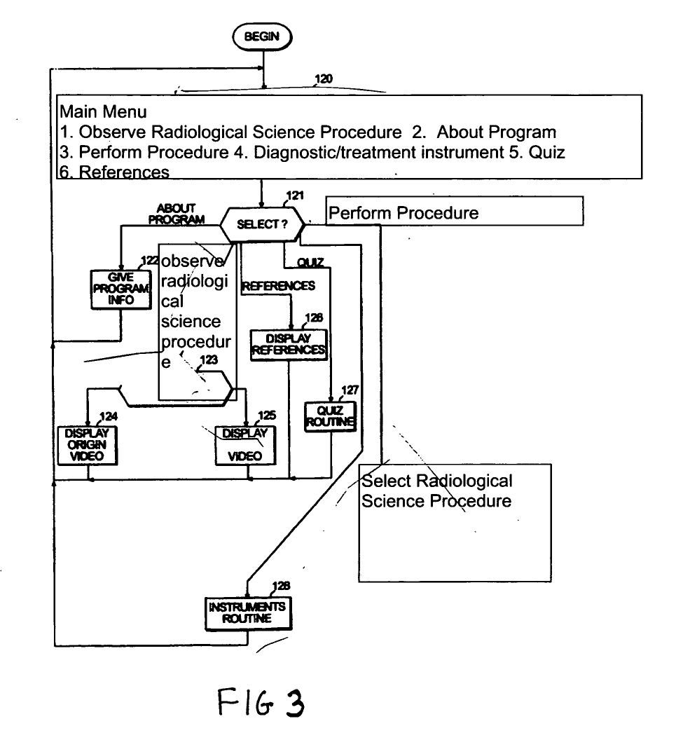

FIG. 3 illustrate flow charts for the other possible users of the computer system 10, using the radiological science procedures as an example. Audio, graphical, and textual data would be provided in the same manner as described above with respect to the other steps in the procedure. The actual output of the remaining display screens and audio screens are dependent on the specific application and may be varied to suit particular preferences. Such modification and applications would be obvious to those skilled in the art.

A program code for the radiological science procedure application of the system can be easily obtained to one skilled in this computer art

The system described herein could easily be translated into foreign languages by modifying the relevant textual and audio data bases. For instance, the audio and textual portions could be easily modified to provide Spanish or French explanations and prompts rather than English. Such modifications would only require modifications to the output data bases and would not require changes to the underlying code structure.

There are many possible modifications and changes which could be made to the system without straying from the applicants' present invention. Such modifications would be obvious to those skilled in the art and should not limit the scope of applicants' claimed invention.

I claim:

1. A method for training users in radiological sciences medical procedures utilizing an interactive computer system, said radiological sciences medical procedure having a plurality of steps, said method comprising the steps of:
(a) requesting a user to input information into said computer system relating to a step in the radiological sciences medical procedure;
(b) said computer system receiving the requested input;
(c) said computer system interpreting the requested input to determine whether it is correct;
(d) said computer system displaying a video segment corresponding to the information inputted by the user relating to said step of the radiological sciences medical procedure, if the input is correct;
(e) said computer system informing the user that the input was incorrect.

2. The method according to claim 1, further including the step of permitting the user to select a radiological sciences medical procedure from a plurality of radiological science procedures.

3. The method according to claim 1, wherein step (a) requests information by displaying a list of selectable options relating to the next step of the radiological sciences medical procedure.

4. The method according to. claim 1, wherein step (a) requests information regarding a diagnostic or treatment instrument, and location relative to a body part for use in the next step of the medical procedure.

5. The method according to claim 1, wherein step (a) requests information regarding a diagnostic and treatment instrument, and location relative to a body part for use in the next step of the medical procedure.

6. The method according to either claim 4, wherein a visual image of said instrument is displayed.

7. The method according to either claim 5, wherein a visual image of said instrument is displayed.

8. The method according to claim 2, wherein the list of options includes a plurality of diagnostic or treatment instruments and positioning relate to body parts for possible use in the next step of the medical procedure.

9. The method according to claim 2, wherein the list of options includes a plurality of diagnostic and treatment instruments and positioning relate to body parts for possible use in the next step of the medical procedure.

10. The method according to claim 1, further including the step of:
(e) returning to step (a) to request the user to input information relating to the next step in the medical procedure, wherein:
(i) the next step is the same as the step from the previous execution of step (a), if the user input was incorrect; and
(ii) the next step is advance beyond the next step from the previous execution of step (a), if the user input was correct.

11. A computer readable storage medium encoded with a computer program for controlling the operation of an interactive radiological sciences medical training system having a display, said storage medium comprising:
means for displaying a first video segment on a portion of the display, the first video segment including a portion of radiological science procedure;
means for displaying a second video segment on the display simultaneously with the first video segment;
said second video segment comprising an alternative view of the same portion of said medical procedure shown in the first video segment to further illustrate body part or positioning;
means for requesting input from a user relating to a step in said medical procedure;
means for receiving the input; and
means responsive to the input for interpreting the input, the interpreting means being operative to inform a user whether the input was correct.

12. A computer readable storage medium encoded with a computer program for controlling the operation of an interactive radiological sciences medical training system having a display, said storage medium comprising:
means for displaying a first video segment on a portion of the display, the first video segment including a portion of radiological science procedure;
means for displaying a second video segment on the display simultaneously with the first video segment;
said second video segment comprising an alternative view of the same portion of said medical procedure shown in the first video segment to further illustrate body part and positioning;
means for requesting input from a user relating to a step in said medical procedure;
means for receiving the input; and
means responsive to the input for interpreting the input, the interpreting means being operative to inform a user whether the input was correct.

13. The computer readable storage medium according to claim 11, wherein the radiological sciences medical training system provides instructive information on radiological science procedures.

14. The computer readable storage medium according to claim 12, wherein the radiological sciences medical training system provides instructive information on radiological science procedures.

15. The computer readable storage medium according to claim 11, further including means for customizing said radiological science procedures based upon selected parameters relating to a patient scenario.

16. The computer readable storage medium according to claim 12, further including means for customizing said radiological science procedures based upon selected parameters relating to a patient scenario.

17. The computer readable storage medium according to claim 16 wherein said parameters are selected from the group consisting of patient weight or patient size.

18. A method for providing a user with training in a radiological science procedures utilizing a self-contained interactive computer system having a video display, a user interface device, and a memory storage device including a plurality of stored video footage relating to various steps in the radiological science procedures, wherein a user selects from among a plurality of available actions relating to the various steps in the radiological science procedures, said method comprising the steps of:
(a) providing a plurality of predetermined available actions relating to the radiological science procedures on a first portion of the video display;
(b) detecting which of the plurality of such predetermined available actions was selected by the user with the user interface device;
(c) displaying on a second portion of the video display portion of the plurality of stored video footage in the memory storage device corresponding to the predetermined available action selected by the user; and
(d) repeating steps (a) through (c) until either all scenarios relating to the radiological science procedures are displayed on the video display, or an erroneous available action is selected by the user.

19. The method of claim 1 wherein the plurality of predetermined available actions provided in step (a) further include a plurality of erroneous radiological science actions for testing the user's knowledge of the radiological science procedure, and the method further comprising the steps of:
providing an error message on the first portion of the video display upon the selection of an erroneous radiological science action by the user; and
providing a return of the video display to enable the user to return to a previously depicted scenario and updating the video display with a portion of the stored data corresponding to the selected action instructing a user as to the results of said erroneous action.
